(19) United States
(12) Patent Application Publication
(10) Pub. No.: US 2008/0122299 A1
(43) Pub. Date: May 29, 2008

(54) MAGNETIC FORCE RECIPROCATING MOTOR

(76) Inventors: Michael Cristoforo, Stuart, FL (US); Stephen Miles, Stuart, FL (US)

Correspondence Address: MCHALE & SLAVIN, P.A., 2855 PGA BLVD, PALM BEACH GARDENS, FL, 33410, US

(21) Appl. No.: 11/563,600

(22) Filed: Nov. 27, 2006

(51) Int. Cl. H02K 7/06; H02K 33/00

(52) U.S. Cl. 310/20; 310/23

(57) ABSTRACT

An electro-magnetic reciprocating engine and method for converting an internal combustion engine to an electro-magnetic reciprocating engine wherein a ferrite magnet is secured to the top of each piston reciprocally disposed in a cylinder, and an electro-magnet spaced apart from said ferrite magnet on the top of each cylinder. The electro-magnets are energized with a constant voltage to create a magnetic field and the ferrite magnets are selectively intermittently polarized when the piston is about one degree past TDC. The ferrite magnets are polarized by contract strike through a distributor allowing the conventional camshaft to provide timing. The distributor is electrically coupled to a DC power source and a capacitor used to provide a stored but adjustable instant burst of voltage to the contact strike to optimize the magnetic field about the ferrite magnet to interact with the magnetic field about the electro-magnet to effect reciprocal motion of the pistons within the cylinders.

### FIELD OF THE INVENTION

This invention relates to vehicle drive motors and more particularly, to vehicle drive motors having reciprocating pistons driven by timed electro magnets.

### BACKGROUND OF THE INVENTION

The internal combustion engine is based upon the use of at least one reciprocating piston that moves up and down inside a cylinder. A one cylinder engine is typically found in lawn mowers. Larger engines, such as those found in an automobile commonly have four, six or even eight cylinders. In a multi-cylinder engine, the cylinders usually are arranged inline, in a V shape, or in a flat/horizontally opposed shape.

In a conventional internal combustion engine, the cylinders and pistons create a chamber where compression and combustion takes place As a piston moves up and down in a cylinder, the difference between the maximum and minimum volume is called the displacement and is measured in liters or cubic centimeters, where 1,000 cubic centimeters equals a liter.

The displacement indicates how much power an engine can produce. A cylinder that displaces half a liter can hold twice as much fuel/air mixture as a cylinder that displaces a quarter of a liter, and therefore you would expect about twice as much power from the larger cylinder.

An internal combustion engine employs a spark to ignite an air/fuel mixture in the combustion chamber. Intake and exhaust valves accompany the cylinder which are timed to open at the proper time allowing air and fuel to enter a cylinder, wherein a spark causes the air/fuel mixture to ignite whereby an exhaust valve is used to remove unused gases. The internal combustion engine is based on the exothermic reaction of a fuel with an oxidizer, commonly air, to create a gas of high pressure. The spark is provided by use of an ignition system which generally consists of a lead-acid battery and an induction coil to provide a high voltage electrical spark to ignite the air-fuel mixture placed in the cylinders. The battery is recharged during operation by use of an alternator driven by the engine. Once the mixture has been ignited within the cylinder, production of hot gas having available energy manifested as work by the engine.

Waste products from the internal combustion engine is heat, which requires elaborate cooling systems to remove, and gas which is vented to the atmosphere and becomes a known pollutant. Most fuels used for internal combustion engines are made up of hydrocarbons derived from petroleum, including gasoline, diesel, liquified petroleum gas, all of which have a finite supply. The amount of pollution that automobiles produce through their internal combustion engine cannot be realistically calculated. Automobiles age, the efficiencies of the automobile changes from driver to driver; environment conditions including heat, cold, terrain, and the age of the automobile provide so many variables that the experts can only concur that the pollution is astronomical.

The need to seek alternative fuels is well documented. However, it would be a tremendous advantage to provide an alternative non-petroleum based power source that can work with existing internal combustion engines. The basis of such a concept is known to be the use of magnets to drive a reciprocating engine. Numerous attempts have been made to utilize permanent magnet pistons as an alternative to the internal combustion engine by use of an electro-magnetic coil to provide reciprocal motion of the pistons to drive an engine.

U.S. Pat. No. 4,317,058, discloses an electro-magnetic reciprocating engine and method for converting an internal combustion engine to an electro-magnetic reciprocating engine wherein the cylinders are replaced with nonferromagnetic material and the pistons reciprocally disposed therein are replaced with permanent magnet pistons. An electro-magnet is disposed at the outer end of each cylinder. A switching and timing apparatus is operably connected between a DC electrical power source and the electro-magnets, whereby the creation of a magnetic field about said electro-magnet will interact with the magnetic field about the permanent magnet pistons to effect reciprocal motion of said pistons within the cylinders. Oil rings are provided around said pistons whereby lubrication can be effected in the same manner as provided in an internal combustion engine.

U.S. Pat. No. 5,592,036, discloses an engine construction having a reciprocating piston attached to a rotating crankshaft, a permanent magnet, cylinder and a head with an electromagnet located therein. A timed switching system reverses the polarity of the electromagnet, thus alternately attracting and repelling the piston and driving the attached rotating crankshaft.

U.S. Pat. No. 5,219,034, discloses a vehicle powered by a magnetic engine, which engine includes a block fitted with multiple cylinders for receiving magnetic pistons attached to a crankshaft and electromagnets mounted in the engine head for magnetically operating the magnetic pistons by electric current reversal. A polarity timer is connected to the vehicle battery through a variable resistor which serves as an accelerator to vary the current through the respective electromagnets and operate the magnetic pistons at a desired speed. Alternating current is generated at the rear axle of the vehicle by means of an alternating current generator, which current is stepped up and rectified to direct current for charging the battery, by operation of a battery charging device.

U.S. Pat. No. 4,523,114, discloses a magnetic reciprocating motor including a block with a crankshaft journalled therein and a cylinder with inboard and outboard portions mounted thereon. A piston with a piston magnet is slidably disposed in the cylinder inboard portion. A carrier assembly reciprocates within the cylinder outboard portion and has a carrier magnet mounted thereon. A head magnet is mounted on a cylinder head attached to the cylinder outboard portion. An electrical distribution system is provided for selectively energizing at least one of the magnets to induce repulsion therebetween for reciprocating the piston and carrier assembly within the cylinder.

U.S. Pat. No. 4,749,893, discloses an engine with a reciprocating piston slidably mounted within a cylinder and connected to a rotatable shaft. The piston is driven back and forth within the cylinder by a pair of electromagnets to obtain rotary power. A secondary winding around one of the electromagnets produces an alternating current. An anti-arc relay is also provided to prevent burning of the high voltage contacts.

U.S. Pat. No. 3,694,679, discloses an electromagnetic engine having a rotational voltage power distributor, an air cooled circular head having fixed electromagnets, an air cooled engine block with a crankshaft and an engine pan having a cooler blower system. The engine block contains electromagnetic pistons. The engine utilizes magnetic attraction and repulsion, in proper timed sequence, of fixed electromagnets in the circular head and the electromagnetic pistons to drive the crankshaft.

U.S. Pat. No. 4,510,420, discloses a pulse width modulator circuit to control the duty cycle pulses applied to coils for rotating an engine. The pulse width modulator (PWM) cooperates with an engine distributor system to generate a procession of pulses which are in turn applied to a power transistor to switch the transistor off and on in timed sequence. This applies power to coils for a magnetic engine. Moreover, two coils are included with each piston and are therefore able to be triggered at different intervals. A modified construction is also disclosed including a pair of coils which are serially positioned but independently connected to cooperate with a sleeve and piston telescoped therein and suitable passages for cooling water are also included.

U.S. Pat. No. 2,338,005 discloses the use of electro-magnetic winding around the cylinders so that a piston member could reciprocate within those windings. The windings within the cylinder greatly limits the size of the electro-magnet since the cylinders on an ordinary internal combustion engine are typically rather close together.

U.S. Pat. No. 4,631,455, discloses an electric starter motor and generator which is integrated into the structure of an internal combustion engine by making the ferromagnetic pistons of the engine the relatively moving elements in the starter and generator. A coil is solenoidally wound around each sleeve of the engine. An electronically controlled switch sends battery current into an appropriate coil inducing a powerful magnetic field therearound. The magnetic field and piston interact resulting in a powerful magnetic force which moves the piston and thus cranks the engine. At appropriate times in the operation of the engine, fuel to the same can be shut off and the engine run as a high speed electric motor.

U.S. Pat. No. 5,457,349, discloses an electromagnetically driven reciprocating engine. Reciprocating pistons are slidably mounted in a cylinder and connected to a rotatable crankshaft. Fixed magnets, preferably of the samarium cobalt alloy type, are mounted in the piston to intermittently attract and repel sequentially energized electromagnets which are mounted in the cylinder walls. The electromagnets are mounted in radially oriented rows and strokewise outwardly extending layers adjacent the cylinder walls. The rows are radially disposed complimentary to the permanent magnets in the piston. The layers are disposed to provide a series of impulses both on the downstroke and on the up stroke, so as to urge the piston in the desired direction and thus turn the crankshaft to provide motive power. A power source for the electromagnets includes a capacitor discharge circuit for directing electrical energy to the electromagnets. A computerized control means regulates the timing of discharge of the capacitors and thus the timing of energizing the electromagnets. A staggered strokewise location for electromagnets which are actuating pistons operating in the same cycle is preferably provided so as to avoid the requirement for simultaneous energization of electromagnets in multiple cylinders; rather, only one layer of electromagnets at one strokewise position is simultaneously energized.

Frenette, U.S. Pat. No. 6,278,204, discloses a method of modifying an internal combustion engine to run on electrical energy. A conventional cylinder head cover of the internal combustion engine is removed and a steel plunger is secured to an end face of each one of the associated pistons. The conventional cylinder head cover is replaced with a modified cylinder head cover which has a solenoid located within each one of the extended cylinder bores, and each solenoid has a central bore for receiving the associated steel plunger. Each solenoid is coupled to a control unit which provides electrical power to each of the solenoids during approximately 180° of rotation of the crankshaft of the engine. The control unit may be a mechanical distributor and relay arrangement or an electronic controller. The pistons work in pairs so that when two of the solenoids are energized, they draw the associated steel plungers within the solenoid central bores while the two remaining solenoids remain de-energized and rotate or reciprocate solely, due to their momentum, to a lower most position. Once the two pistons, associated with the energized solenoids, reach their upper most rotational or reciprocal position, the associated solenoids are de-energized and the other two solenoids are energized. The sequential energization/de-energization of the first and second pairs of solenoids causes the crankshaft to rotate in a desired direction and provide driving output in a conventional manner. The cylinder head cover is provided with an internal coolant cooling system for cooling the solenoids, during operation of the engine, to prevent overheating thereof.

Hartmen, Sr., U.S. Pat. No. 4,684,834, discloses an electromagnetic motor apparatus and is used for converting electrical energy into rotary motion and includes a housing having a crankshaft rotatably mounted therein. A plurality of stators form cylinders and are mounted onto the housing. A plurality of armatures form the pistons and are movably mounted to slide in the stators. Each armature has an armature piston rod connected to each armature and to the crankshaft for turning the crankshaft responsive to the movement of the armatures in a timed sequence. A distributor is operatively connected to the crankshaft for distributing electrical energy applied to the distributor from the distributor to the stator windings. The distributor has at least one pair of electrical contacts moving in a liquid bath responsive to the rotation of the crankshaft to direct electrical energy to the stator in timed sequence so that electrical arcing is reduced in the distribution of the electrical energy in an electromagnetic motor.

Thus, what is lacking in the art is a means timed energizing of the magnets for use in a reciprocating motor, thus providing the missing link in converting internal combustion engines to a magnetic force reciprocating motor with sufficient power to properly propel a vehicle.

### SUMMARY OF THE INVENTION

The present invention is based on a kit for converting a conventional internal combustion engine to a magnetically driven motor. The kit is used in combination with a conventional internal combustion engine having an engine block for containing lubricant, a crankshaft rotatably coupled to at least one cylinder slidably disposed in a cylinder, a valve head secured to one end of said cylinder, said valve head having an intake and exhaust valve, and a spark plug that receives a timed ignition spark from a distributor.

The engine kit includes a spacer that is positionable between the valve head and the engine block, in placement of the conventional head gasket. The spacer includes at least one electro-magnet that is positionable directly above each cylinder. When the operation of the engine is required, a constant voltage is delivered to the electro-magnet to produce a first magnetic field.

A ferrite magnet is permanently attached to each piston by use of a non-conducting material such as 3M's 5200. The ferrite magnet is selectively intermittently polarizing by use of a contact strike that extends into the cylinder and is in contact with the ferrite magnet for a period extending about one degree before top dead center TDC to one degree after top dead center. The contact point is energized at about one degree past TDC to cause a repulsion with the polarized electro magnet to effect reciprocal movement of the ferrite magnet secured to the piston within the cylinder. To eliminate pressure associated with a conventional combustion chamber, the spark plug are removed and provide a compression relief port.

An objective of the invention is to provide a kit for converting a conventional internal combustion engine to a magnetically driven motor.

Another objective of the invention is to teach the use of a constant polarized electro-magnet that is repelled by a ferrite magnet that is polarized after the piston reaches TDC.

Yet another objective of the invention is to eliminate the need for extensive modifications to the internal combustion engine by allowing most mechanical changes to take place upon replacement of the head gasket with a spacer having an electro-magnet incorporated therein.

Still another objective of the invention is to address the fuel shortage and provide an alternative to simply having to scrap existing automobiles due to the fuel shortage.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### DESCRIPTION OF THE DRAWINGS

FIG. 1 is a cross sectional end view of a conventional four-cycle internal combustion engine;

FIG. 2 is a cross sectional end view of a conventional internal combustion engine including an electro-magnetic reciprocating engine;

FIG. 3 is a sectional view of a piston at one degree TDC;

FIG. 4 is a sectional view of a piston in a power stroke;

FIG. 5 is a sectional view of a piston in an exhaust stroke; and

FIG. 6 is a pictorial illustration of an electrical schematic.

### DESCRIPTION OF THE PREFERRED EMBODIMENT

Although the invention will be described in terms of a specific embodiment, it will be readily apparent to those skilled in this art that various modifications, rearrangements and substitutions can be made without departing from the spirit of the invention. The scope of the invention is defined by the claims appended hereto.

Now referring to the drawings, a four-cycle internal combustion engine 10 is depicted having an engine block member 12 with a crankshaft 14 being journalled therein. Cylinders 16 are formed integral with the block member 12 with cooling water jackets 18 surrounding the cylinders 16. Reciprocating piston members 20 are slidably disposed within the cylinders 16 and secured to the crankshaft 14 by connecting rods 22. Secured to the engine block member 12, along the outer ends of the cylinder 16 are head members 24 which contain intake valve members 26 and exhaust valve members 27 therein. A head gasket 29 is used to seal the engine block to the head members 24, the area between the pistons members 20 and the head members 24 forming a combustion chamber 31. The valve members 26 & 27 are operated by valve lifters 28 moved by a cam shaft 30 coupled to the crankshaft 14 to allow timed introduction of an air/fuel mixture from a manifold 31 to enter through the intake valve 26. Upon rotation of the crankshaft, the pistons compress the air/fuel mixture in the combustion chamber wherein spark plugs 34 caused the mixture to explode. The explosion resulting in the expansion of gases resulting in the movement of the piston 20. Exhaust valve 27 allows spent gases to be removed from the cylinder on a rotation stroke where the piston extends into the combustion chamber with no spark ignition.

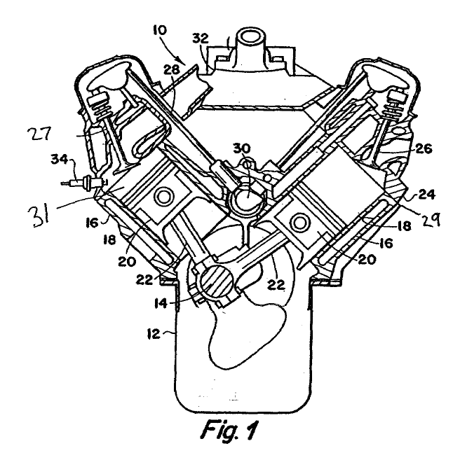

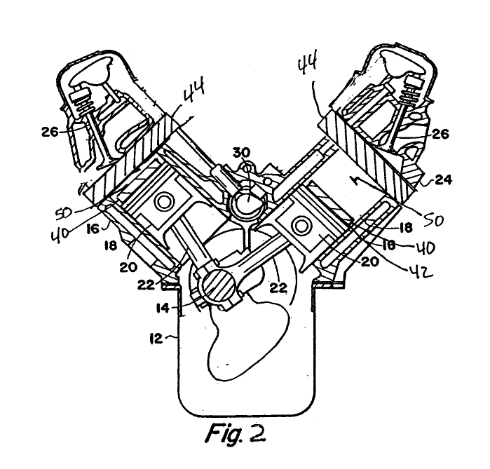

Referring now to FIG. 2, an electro-magnetic reciprocating engine 40 having a conversion kit of the instant invention installed on the engine depicted in FIG. 1. In this embodiment, each piston includes a ferrite magnet 40 secured to the piston by use of a non-metallic adhesive 42 such as 3M's 5200 adhesive. Contained within the cylinder members 16 are suitable cooling water jackets 18, however, the need for cooling is reduced to the friction caused by the reciprocating pistons and polarized magnets. Journalled within the engine block 12 remains the crank shaft 14.

A plurality of electro magnets are placed within a spacer 44 used in place of the conventional head gasket. The spacer 44 is approximately two inches thick and can be made of a non-sealing material, non-conducting material such as cork, rubber, aluminum, plastic, and the like. The spacer includes electro-magnets 46 having leads that are electrically coupled to a power source. When the engine is placed into a “run” position, the electro-magnets are polarized.

The ferrite magnets 40 are polarized by use of a contract strike 50 formed from a flexible conducting material. The contact strike is electrically coupled to a distributor, not shown. In the conversion of a BMW 2.7 liter flat head six, the ferrite magnet is approximately three inches in diameter and one and a half inches thick. The distributor is in turn electrically connected to a DC power source through an electrical coil, such as a capacitor described later in this specification. Control of the capacitor is provided by a suitable operator's control member such as the accelerator pedal. In operation, the electro-magnetic engine is lubricated in the manner provided by an ordinary internal combustion engine. It should be noted that the carburetor, fuel pump, intake manifold, exhaust manifold, push rods, spark plugs, and fuel tank may be removed if additional weigh savings are desired.

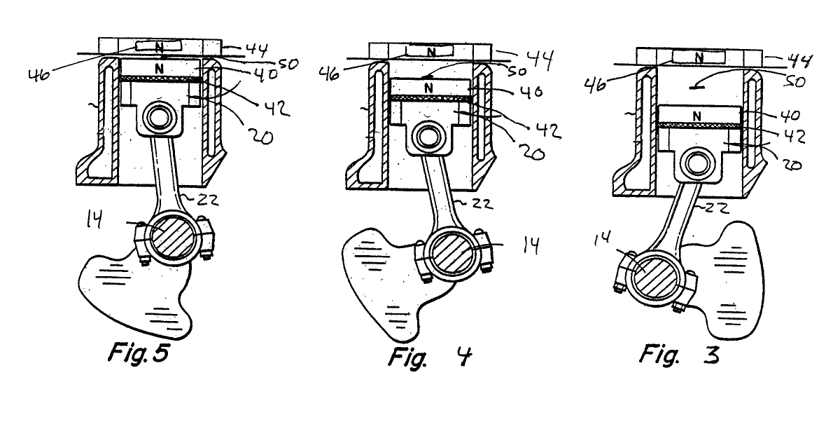

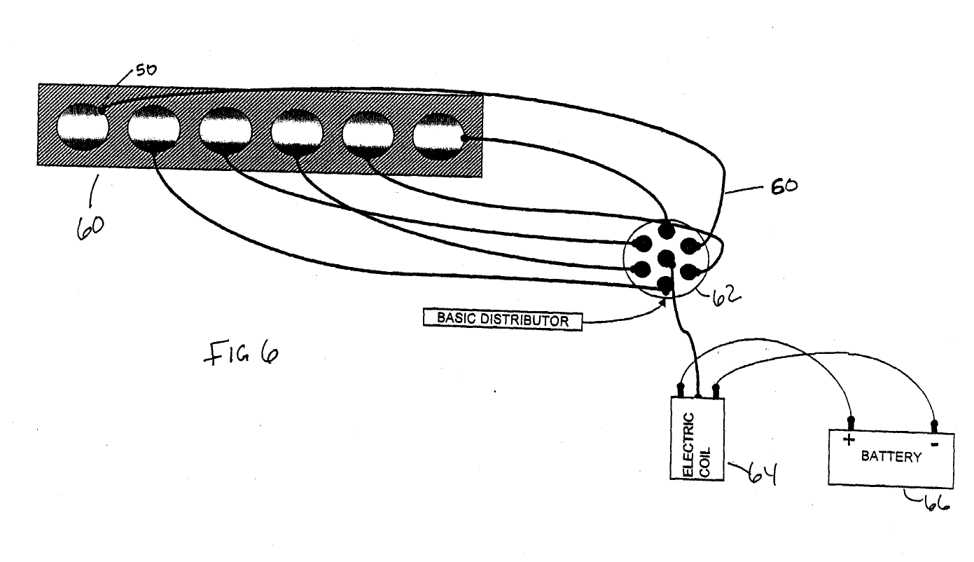

The pistons 20 are driven by opposing magnetic fields as depicted in the piston diagrams of FIGS. 5, 6 and 7. FIG. 5 depicts the piston 20 after it has just passed top dead center TDC of its stroke. At about one degree TDC the contract strike 50 receives an input of voltage causing the ferrite magnet 40 to become the same polar as the electro-magnet 46 causing a repulsion of the magnets. The polar magnetism is depicted as N, but the polar magnetism may also be S. Therefore, as the contact strike is energized as shown in FIG. 3 a downward force is applied to the piston due to opposing magnetic fields thereby forcing the piston through a power stroke as shown in FIG. 4 which in turn rotates the crank shaft 14 of the engine. The contact strike remains energized as the piston is pushed into a power stoke shown in FIG. 4. When the piston 20 is clear of the contact strike, power to the contact strike is removed. After the piston 20 has completed its power stroke and is on a return stroke as shown in FIG. 5, the contract strike 50 is de-energized and the ferrite magnet 40 has lost its polarity. After the piston completes its return stroke and returns to the power stroke, as shown in FIG. 4, the contact strike 40 is energized again when the piston is about one degree TDC to provide a subsequent power stroke. In the present invention, however, every time the piston passes dead center, electrical power may be provided to the electro-magnet 54 producing a power stroke. Stated another way, for each rotation of the crank shaft 48, each piston can experience a power stroke.

It should be noted that whereas the drawings and specification herein depict an engine with a V-block configuration, the present invention is suitable for application to any style of internal combustion engine including, but not limited to, in-line cylinders, opposing cylinders, radial engines and even single piston engines.

FIG. 6 depicts an in-line six cylinder engine with the contact wherein the contact strikes 50 are electrically coupled by connecting wires 60 to a distributor 62. The distributor 62 includes a rotor, not shown that is timed from the camshaft to provide a controlled voltage spike to the ferrite magnets when the pistons reach approximately one degree TDC. The voltage spike is produced by an electric coil 64, or a capacitor not shown, for use in high voltage spikes. A battery 66 provides the electrical power, the battery is recharged in the conventional manner by use of engine driven alternator.

It is to be understood that while we have illustrated and described certain forms of the invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

What is claimed is:

1. An electro-magnetic reciprocating engine kit for use in combination with a conventional internal combustion engine having an engine block for containing lubricant, a crankshaft rotatably coupled to at least one cylinder slidably disposed in a cylinder, a valve head secured to one end of said cylinder, said valve head having an intake and exhaust valve, and a spark plug that receives a timed ignition spark from a distributor, said engine kit comprising: spacer means positionable between said valve head and said engine block, at least one electro-magnet secured to said spacer means and positioned directly above each said cylinder; power means for providing a constant power to each said electro magnet; a ferrite magnet permanently attached to each said piston; strike means for selectively intermittently polarizing said ferrite magnet; and a compression relief port; whereby said ferrite magnet is polarized to cause a repulsion with said electro magnet to effect reciprocal movement of said piston within the cylinder.

2. An electro-magnetic reciprocating engine kit as set forth in claim 1 wherein said strike means is a contact wire receiving timed voltage from a distributor, said distributor selectively energizing said contact wire at about one degree past TDC.

3. An electro-magnetic reciprocating engine kit as set forth in claim 1 wherein the ferrite magnet is secured to said piston by a non-conducting material.

4. An electro-magnetic reciprocating engine kit as set forth in claim 3 wherein said non-conducting material is 3M 5200.

5. An electro-magnetic reciprocating engine kit as set forth in claim 1 wherein said spark plug holders are compression relief ports.

6. An electro-magnetic reciprocating engine kit as set forth in claim 1 wherein the power means is an electrical battery.

7. An electro-magnetic reciprocating engine kit as set forth in claim 1 wherein said distributor is electrically coupled to a capacitor, said capacitor storing voltage to provide said contact wire with a high voltage spike.

8. An electro-magnetic reciprocating engine as set forth in claim 7 wherein said capacitor is adjustable for varying the amount of power provided intermittently to said ferrite magnet.

9. An electro-magnetic reciprocating engine kit for use in combination with a conventional internal combustion engine having an engine block for containing lubricant, a crankshaft rotatably coupled to at least one cylinder slidably disposed in a cylinder, a valve head secured to one end of said cylinder, said valve head having an intake and exhaust valve, and a spark plug that receives a timed ignition spark from a distributor, said engine kit comprising: spacer means positionable between said valve head and said engine block, at least one electro-magnet secured to said spacer means and positioned directly above each said cylinder; power means for providing a constant power to each said electro magnet; a ferrite magnet adhesively attached to each said piston; a contact strike wire positionable within a cylinder, said contact strike wire for selectively intermittently polarizing said ferrite magnet; a distributor selectively energizing said contact wire at about one degree past TDC; and a compression relief port; whereby said ferrite magnet is polarized to cause a repulsion with said electro magnet to effect reciprocal movement of said piston within the cylinder.

10. An electro-magnetic reciprocating engine kit as set forth in claim 9 wherein said adhesive is 3M 5200.

11. An electro-magnetic reciprocating engine kit as set forth in claim 9 wherein said distributor is electrically coupled to a capacitor, said capacitor storing voltage to provide said contact wire with a high voltage spike.

12. An electro-magnetic reciprocating engine as set forth in claim 11 wherein said capacitor is adjustable for varying the amount of power provided intermittently to said ferrite magnet.
